(19) United States
(12) Patent Application Publication
(10) Pub. No.: US 2019/0119910 A1
(43) Pub. Date: Apr. 25, 2019

(54) WATERPROOF STRUCTURE, WATERPROOF SHEET AND WATERPROOFING METHOD

(71) Applicant: DYFLEX CORPORATION, Tokyo (JP)

(72) Inventors: Yasuhiro YOKOCHI, Funabashi City (JP); Soichi YOSHIKAWA, Funabashi City (JP); Shigetaka SHIMIZU, Funabashi City (JP); Kenji KUMAGAI, Funabashi City (JP)

(73) Assignee: DYFLEX CORPORATION, Tokyo (JP)

(21) Appl. No.: 16/170,155

(22) Filed: Oct. 25, 2018

(30) Foreign Application Priority Data
Oct. 25, 2017 (JP) 2017-206229

(51) Int. Cl. E04B 1/62; B32B 7/14; B32B 27/30; B32B 3/02; B32B 37/24; B32B 37/12

(52) U.S. Cl. CPC E04B 1/62; B32B 7/14; B32B 27/304; B32B 3/02; B32B 37/24; B32B 37/1292; E04D 5/06; B32B 2255/10; B32B 2307/7265; B32B 2419/00; B32B 2327/06; B32B 2037/243; B32B 2255/26

(57) ABSTRACT

A waterproof structure which does not require use of fixing tools, suppresses swelling and is easily installed. A waterproof structure provided with a waterproof sheet, which is laid on a part of a target region of a foundation that is a flat site, and a waterproof coating film, which is formed on at least a part of a peripheral region. The waterproof sheet has a resin sheet containing a poly(vinyl chloride)-based resin and an adhesive layer which is provided on one side of the resin sheet and which is bonded to the foundation. The adhesive layer is provided on a partial region of the resin sheet. The waterproof coating film contains a polyurethane-based resin and is provided so as to be in contact with the resin sheet on at least a surface of a rim part of the waterproof sheet.

### TECHNICAL FIELD

The present invention relates to a waterproof structure, a waterproof sheet and a waterproofing method.

### BACKGROUND ART

Waterproofing techniques for structures such as buildings mainly involve sheet waterproofing and urethane coating film waterproofing.

In sheet waterproofing, a sheet comprising poly(vinyl chloride) or the like is cut to match the shape of an installation target and bonded. Sheets are produced in advance in a factory, and are therefore formed uniformly at a fixed quality. Sheet waterproofing is a dry process and does not require curing time, and is therefore efficient for installing in targets having large areas.

In sheet waterproofing, the quality achieved at locations where sheets are joined to each other depends on the skill of the installer. In particular, in cases where installation is carried out at regions surrounding a target region or carried out on an installation target having a complex shape, many joints can occur, meaning that installation is not easy in many cases and installers require training. Sheet manufacturers etc. provide education for installers and carry out activities so that waterproofing performance is ensured, but because there is a shortage of installers in the construction industry, it is not easy to find trained installers. Therefore, it can be said that sheet waterproofing involves a high degree of difficulty.

In sheet waterproofing, sheets are mechanically fixed to a foundation. For example, the rim part of a sheet is fixed by means of thermal bonding or the like to a resin-coated steel sheet that is fixed to a foundation by means of fixing tools such as bolts or anchors. Such mechanical fixing methods are preferred from the perspective of being able to carry out installation regardless of the moisture conditions and degree of unevenness of the foundation. In such installation methods, however, noise and vibration occur when holes for fixing tools are formed in the foundation. Consideration has had to be given to noise and vibration in recent years, due to an increase in repair work over new constructions. Therefore, there has been a need for measures such as providing information in advance regarding specified times for drilling work, and this leads to work periods being extended and costs increasing.

In such installation methods, a sheet is fixed at points or in lines, not planarly, to an installation target, meaning that a bonded structure is formed in which the majority of the sheet is loose. Therefore, in areas of strong wind, such as in coastal regions or high-rise buildings, sheets flutter and fixing points are easily damaged in strong winds, meaning that such installation methods are often avoided in areas of strong wind.

Installation methods involving bonding sheets to foundations by means of adhesives (adhesion installation methods) also exist, but in such installation methods, noise and vibration do not occur, but it is necessary to coat an adhesive on the back surface of the sheet and both surfaces of the foundation, and installation efficiency tends to be low. In addition, because the entire surface of the sheet is bonded to the foundation by means of an adhesive, moisture contained in a framework (concrete) forms water vapour when the temperature of the framework rises as a result of solar radiation and the like, and this can lead to swelling.

Meanwhile, in urethane coating film waterproofing, a liquid waterproofing material is applied to an installation target and the applied waterproofing material is cured so as to form a waterproof coating film, meaning that it is possible to form a waterproof coating film having no joints even in cases where an installation target has a complex shape. Urethane coating film waterproofing has the advantage of being able to be applied relatively easily to installation targets having complex shapes.

In urethane coating film waterproofing, however, liquid waterproofing materials readily flow along gradients and unevenness in foundations, meaning that it can be difficult to form a waterproof coating film having a uniform thickness and a partial decrease in waterproofing performance can occur. In addition, a certain period of time (curing time) is required between the liquid waterproofing material being applied and the coating film being cured, meaning that work periods tend to be longer.

Patent Document 1 discloses a waterproof sheet having a waterproof layer comprising a vinyl chloride resin and a self-adhesive layer comprising an adhesive gelatinous material. This waterproof sheet is planarly fixed to a surface to be waterproofed by means of the self-adhesive layer, and can therefore readily be used in areas of strong wind. In addition, because a self-adhesive layer is provided, there is no need to apply an adhesive and installation efficiency can be increased. The above-mentioned problems inherent in urethane coating film waterproofing (a partial reduction in waterproofing performance and longer work periods) can be solved. In this waterproof sheet, however, fixing tools are sometimes used to fix the edge of the sheet to the surface to be waterproofed, and in such cases, the problem of noise and vibration mentioned above occurs. In addition, the problem of swelling mentioned above is not solved by this waterproof sheet. Furthermore, in cases such as those where an installation target has a complex shape, it cannot be said that installation is easy because there are many joints between sheets and waterproofing needs to be ensured between joints.

### CITATION LIST

### Patent Literature

[Patent Document 1] Japanese Patent Application Publication No. 2016-113790

### SUMMARY OF INVENTION

### Technical Problem

In view of the circumstances mentioned above, the purpose of the present invention is to provide a waterproof structure, waterproof sheet and waterproofing method which do not require the use of fixing tools, suppress swelling and facilitate installation.

### Solution to Problem

In order to solve the problems mentioned above, one aspect of the present invention provides a waterproof structure which is provided with a waterproof sheet, which is laid on a part of a target region of a foundation that is a flat site, and a waterproof coating film that is formed on at least a part of a peripheral region of the target region on which the waterproof sheet is not laid, wherein the waterproof sheet has a resin sheet containing a poly(vinyl chloride)-based resin and an adhesive layer which is provided on one side of the resin sheet and which is bonded to the foundation, the adhesive layer is provided on a partial region of the resin sheet, and the waterproof coating film contains a polyurethane-based resin and is provided so as to be in contact with the resin sheet on at least a surface of a rim part of the waterproof sheet.

It is preferable for at least the surface of the resin sheet that is in contact with the waterproof coating film to contain a reactive material, and for the reactive material to have or generate a functional group capable of reacting with a component of the polyurethane-based resin.

The functional group is preferably at least one type selected from among a hydroxyl group, an amino group, a carboxyl group and a thiol group.

The resin sheet preferably has an amount of shrinkage in a thermally stretched state, as specified in JIS A6008, of 4 mm or less.

In the waterproof structure, a breathable ventilation layer is provided between one face of the resin sheet and the adhesive layer.

One aspect of the present invention provides a waterproof sheet, which has a resin sheet containing a poly(vinyl chloride)-based resin and an adhesive layer which is provided on one side of the resin sheet and which is bonded to a foundation, wherein the adhesive layer is provided on a partial region of the resin sheet, at least the other face of the resin sheet contains a reactive material, and the reactive material has or generates a functional group capable of reacting with a component of the polyurethane-based resin.

One aspect of the present invention provides a waterproofing which includes a first step of laying a waterproof sheet on a part of a target region of a foundation that is a flat site, and a second step of forming a waterproof coating film on at least a part of a peripheral region of the target region on which the waterproof sheet is not laid, wherein the waterproof sheet has a resin sheet containing a poly(vinyl chloride)-based resin and an adhesive layer which is provided on one side of the resin sheet and which is bonded to the foundation, the adhesive layer is provided on a partial region of the resin sheet, and the waterproof coating film contains a polyurethane-based resin and is provided so as to be in contact with the resin sheet on at least a surface of a rim part of the waterproof sheet.

It is preferable for at least the surface of the resin sheet that is in contact with the waterproof coating film to contain a reactive material, and for the reactive material to have or generate a functional group capable of reacting with a component of the polyurethane-based resin.

### Advantageous Effects of Invention

According to an embodiment of the waterproof structure, the waterproof coating film is strongly bonded to the resin sheet, meaning that it is possible to avoid the occurrence of peeling between the resin sheet and the waterproof coating film. Therefore, it is possible to obtain a waterproof structure having excellent waterproofing performance even in cases where an installer does not possess special skills. Therefore, there are no restrictions such as requiring installation by skilled installers, and installation can be easily carried out. In this waterproof structure, because the adhesive layer is formed only on a partial region of the resin sheet, in cases where gas such as water vapour is generated from the foundation, this gas flows into spaces between the foundation and parts where the adhesive layer has not been formed (non-formed parts). As a result, it is possible to suppress a pressure increase caused by this gas and prevent swelling of the waterproof sheet. In this waterproof structure, because the waterproof coating film is provided from the rim part of the waterproof sheet to the peripheral region, the waterproof sheet can be fixed to the foundation without using fixing tools. Because fixing tools are not required, noise and vibration caused by drilling work does not occur.

### BRIEF DESCRIPTION OF DRAWINGS

FIG. 1 is a cross-sectional view that schematically illustrates an embodiment of a waterproof structure.

FIG. 2 is a perspective view that schematically illustrates a waterproof sheet used in the waterproof structure shown in FIG. 1.

FIG. 3 is a perspective view of the waterproof sheet shown in FIG. 1.

FIG. 4 is a cross-sectional view of the waterproof sheet shown in FIG. 1.

FIG. 5 is a perspective view of a waterproof sheet used in another embodiment of a waterproof structure.

### DESCRIPTION OF EMBODIMENTS

### Waterproof Structure

An embodiment of a waterproof structure will now be explained in detail, with reference to the drawings.

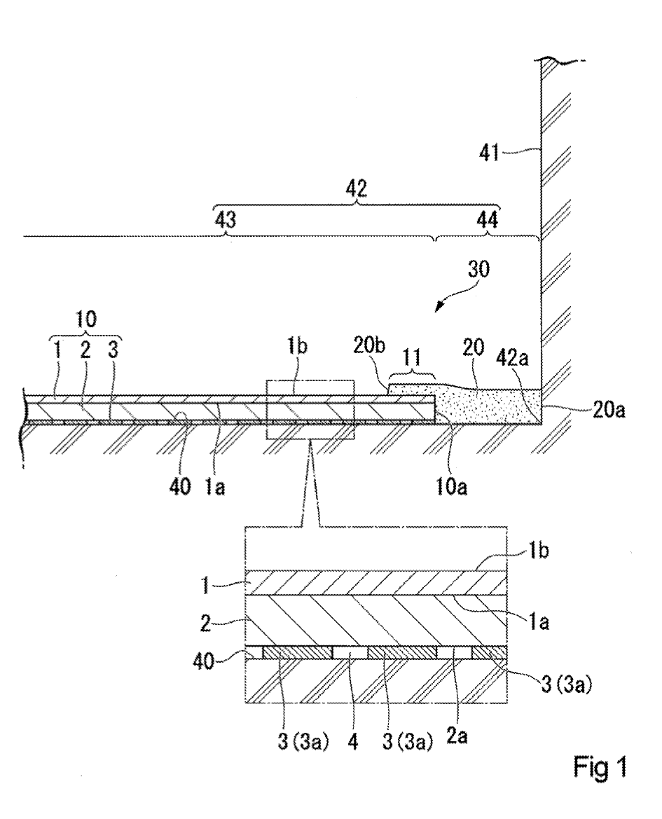

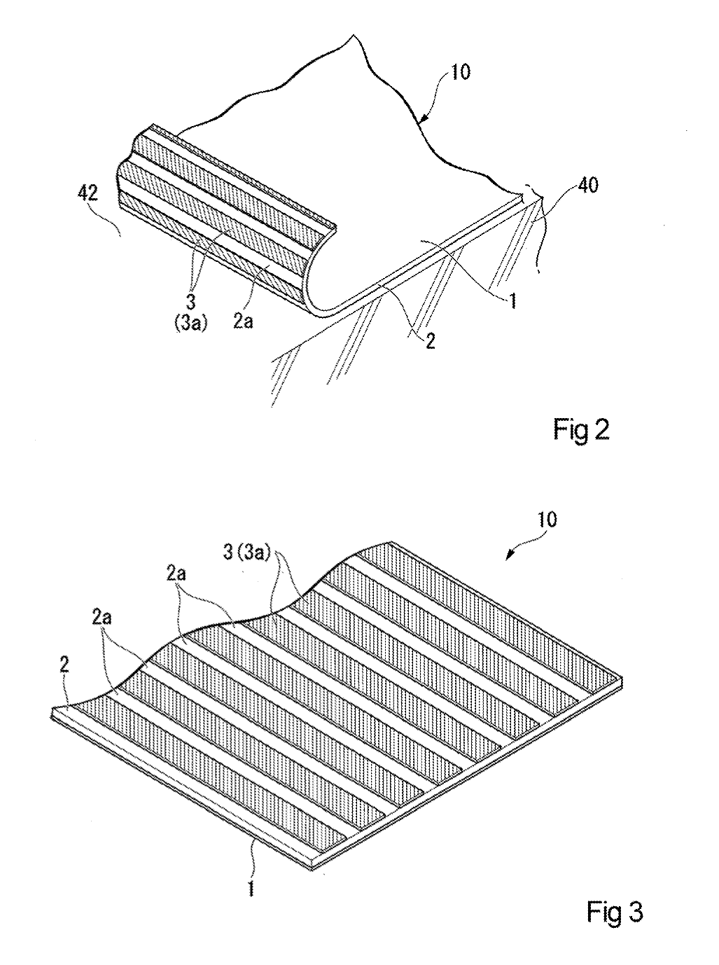

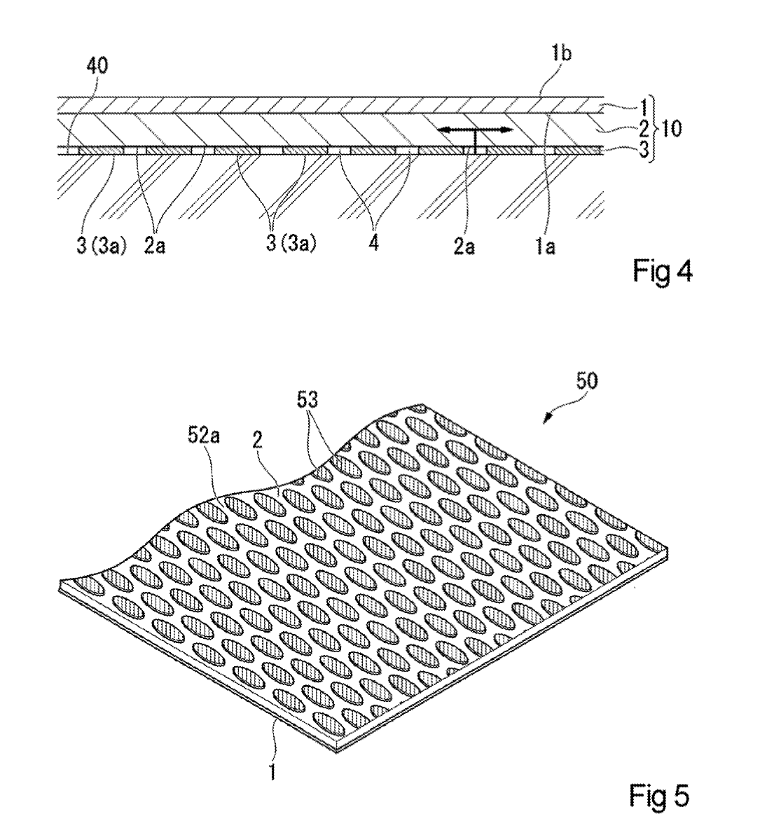

FIG. 1 is a cross-sectional view that schematically illustrates an embodiment of a waterproof structure 30. FIG. 2 is a perspective view that schematically illustrates a waterproof sheet 10 used in the waterproof structure 30. FIG. 3 is a perspective view of the waterproof sheet 10. FIG. 4 is a cross-sectional view of the waterproof sheet 10. In the explanations given below, “upper” and “lower” are defined according to the up-down direction shown in FIG. 1. In FIG. 1, among a resin sheet 1, a ventilation layer 2 and an adhesive layer 3, the resin sheet 1 is positioned uppermost and the adhesive layer 3 is positioned lowermost. A planar view means seen from a direction that is parallel to the thickness direction of the waterproof sheet 10.

As shown in FIG. 1, the waterproof structure 30 can be such that, for example, a foundation 40 (a concrete floor) that is a flat site surrounded by a parapet 41 on the roof of a concrete building is provided as a target region. Flat site means, for example, a surface that is horizontal or approximately horizontal. Here, the entire foundation 40 surrounded by the parapet 41 is the target region 42 for waterproofing.

The target region 42 has a laying region 43, on which the waterproof sheet 10 is laid, and a peripheral region 44. The laying region 43 is, for example, a region having a rim that is distant from the parapet 41 by a fixed distance. The peripheral region 44 is a region of the target region 42 on which the waterproof sheet 10 is not laid and is, for example, a region that is delineated by the rim of the target region 42 and the parapet 41. The peripheral region 44 is an annular region having a fixed width that surrounds the laying region 43.

As shown in FIG. 1, the waterproof structure 30 is provided with the waterproof sheet 10 and the waterproof coating film 20.

As shown in FIGS. 1 to 3, the waterproof sheet 10 is provided with the resin sheet 1, the ventilation layer 2 and the adhesive layer 3.

The resin sheet 1 contains a poly(vinyl chloride)-based resin. The poly(vinyl chloride)-based resin may be poly(vinyl chloride) that is a homopolymer of vinyl chloride or a copolymer of vinyl chloride and another monomer. Examples of monomers able to be copolymerised with vinyl chloride include vinylidene chloride, vinyl acetate, ethylene, acrylonitrile and (meth)acrylic acid esters. The resin sheet 1 may be formed from a mixture of a poly(vinyl chloride)-based resin and another resin.

The thickness of the resin sheet 1 can be, for example, 10-2000 μm. Waterproofing properties can be increased by means of the resin sheet 1. 1a is the lower face (first face, one face) of the resin sheet 1, and 1b is the upper face (second face, other face) of the resin sheet 1.

The resin sheet 1 preferably contains a reactive material. The reactive material can react with a component of the waterproof coating film 20 that contains a polyurethane-based resin. Specifically, the reactive material corresponds to [1] or [2] below.

[1] A reactive material having a functional group that is capable of reacting with an isocyanate contained in the polyurethane-based resin.
[2] A reactive material that reacts with a latent curing agent contained in the waterproof coating film 20 and generates a functional group that is capable of reacting with a component of the waterproof coating film 20.

In [1], the “functional group that is capable of reacting with an isocyanate” is, for example, an active hydrogen-containing functional group. Examples of the “functional group that is capable of reacting with an isocyanate” include at least one type from among a hydroxyl group (—OH), an amino group (—NH₂ etc.), a carboxyl group (—COOH) and a thiol group (—SH). Of these, hydroxyl groups and amino groups are particularly preferred from the perspective of obtaining a waterproof structure 30 having excellent long-term stability. As this functional group, it is possible to use only one type of group selected from among a hydroxyl group, an amino group, a carboxyl group and a thiol group, or a combination of two or more types thereof

Examples of reactive materials having a hydroxyl group include poly(vinyl chloride)-based resins having a hydroxyl group added to the poly(vinyl chloride) skeleton. A resin having a hydroxyl group added to the skeleton may be a resin other than a poly(vinyl chloride)-based resin. Examples of reactive materials having a hydroxyl group include compounds such as vinyl alcohol-based compounds and saponified compounds. Poly(vinyl alcohol) (PVA), ethylene-vinyl alcohol copolymers (EVOH), ethylene-vinyl acetate-vinyl alcohol copolymers, and the like, can be used as vinyl alcohol-based compounds. Examples of saponified compounds include saponified ethylene-vinyl acetate copolymers.

Examples of reactive materials having an amino group include poly(vinyl chloride)-based resins having an amino group added to the poly(vinyl chloride) skeleton. A resin having an amino group added to the skeleton may be a resin other than a poly(vinyl chloride)-based resin. Reactive materials having an amino group include polyaminostyrene and polyvinylamine. In addition, it is possible to use compounds obtained by incorporating amino groups in styrene-butadiene copolymers.

Examples of reactive materials having carboxyl groups include poly(acrylic acid) and carboxymethyl cellulose.

Examples of reactive materials having thiol groups include 1,2-ethanedithiol and 1,2-propanedithiol.

The reactive material of [2] above has a functional group, but this functional group, prior to reacting with a latent curing agent, is masked by a corresponding chemical substance and is not reactive. At least during the period between formation of the waterproof coating film 20 and curing, the masked chemical substance can be reversibly removed from the functional group, thereby generating a functional group that is capable of reacting with a component of the waterproof coating film 20. Here, a “latent curing agent” is a compound that generates at least one of an isocyanate group, hydroxyl group, amino group, carboxyl group or thiol group by the effect of heat, the action of moisture or the action of a chemical substance.

A catalyst for accelerating the curing reaction of the liquid waterproofing material (for example, a metal salt of an organic acid, an organometallic compound, or the like) may be added to the reactive material.

The resin sheet 1 preferably has an amount of shrinkage in a thermally stretched state (as specified in JIS A6008) of 4 mm or less. In this way, the resin sheet 1 is unlikely to expand and contract even if a tensile force is applied, and it is therefore possible to avoid the occurrence of peeling between the resin sheet 1 and the waterproof coating film 20 as time passes. As a result, waterproofing performance reliability can be increased.

The ventilation layer 2 is laminated on the lower face la (first face) of the resin sheet 1. The ventilation layer 2 is provided on the entire region of the lower face la of the resin sheet 1.

The ventilation layer 2 is configured so as to be breathable. The ventilation layer 2 can be a cloth material such as a non-woven fabric, a woven fabric or a net cloth (a mesh cloth). The cloth material is formed as a fabric or mesh from single fibres or bundled fibres, or is obtained by combining a plurality of these.

Fibres that constitute the ventilation layer 2 may be synthetic fibres such as polyester, acrylic, nylon, polypropylene, polyamide or poly(vinyl alcohol); organic fibres such as natural fibres, such as cotton or hemp; or inorganic fibres such as glass, metals or carbon. Of these, a non-woven fabric comprising a polyester is preferred from perspectives such as weathering resistance, mechanical strength and adhesive properties of an adhesive for foundation bonding.

The non-woven fabric can be one produced using a conventional technique, such as needle punching, a resin binder or a heat fusion bonding method, but needle punching is preferred from the perspective of being able to obtain a non-woven fabric having a sufficient thickness and excellent breathability.

The mass per unit area of the ventilation layer 2 is preferably 500 g/m² or less because breathability decreases if this mass per unit area is too high. By setting the mass per unit area to fall within this range, sufficient breathability can be achieved. In addition, because damping performance deteriorates if the mass per unit area is too low, the mass per unit area is preferably 50 g/m² or more.

Because the amount of ventilation decreases if the ventilation layer 2 is too thin, it is suitable for the thickness of the ventilation layer 2 to be 0.2 mm or more, and preferably 0.5 mm or more. In addition, if the ventilation layer 2 is too thick, the thickness of the waterproof sheet 10 increases, flexural rigidity increases and ease of installation is poor, and the thickness of the ventilation layer 2 is therefore preferably 3 mm or less.

The ventilation layer 2 exhibits excellent elasticity, and therefore imparts the waterproof sheet 10 with damping performance whereby it is possible to absorb forces applied by people walking and stresses caused by concrete shrinking.

The adhesive layer 3 is suitably a material that exhibits self-adhesive properties, and can be an asphalt-based material, such as a polymer-modified asphalt, or a rubber-based material (such as a butyl rubber).

As shown in FIGS. 2 and 3, the adhesive layer 3 is formed only on a part of the lower face of the ventilation layer 2, not the entire surface thereof. That is, the adhesive layer 3 is formed on a partial region of the lower face of the ventilation layer 2 in a planar view. It can be said that the adhesive layer 3 is formed on a partial region of the lower face la of the resin sheet 1 via the ventilation layer 2.

The adhesive layer 3 comprises, for example, a plurality of band-like parts 3a formed at intervals in the width direction. The band-like parts 3a are formed continuously in a fixed direction. The band-like parts 3a are approximately parallel to each other. Because the adhesive layer 3 comprises band-like parts 3a, those parts of the ventilation layer 2 on which the adhesive layer 3 is not formed (hereinafter referred to as non-formed parts 2a) are also in the form of bands that extend continuously along the length direction of the band-like parts 3a. Therefore, the non-formed parts 2a are continuous in the length direction of the adhesive layer 3, but discontinuous in the width direction.

From the perspective of ensuring breathability, the thickness of the adhesive layer 3 is preferably determined so as to ensure a space 4 of a sufficient size (cross-sectional area) between non-formed parts 2a and the foundation 40 (see FIG. 4). It is suitable for the thickness of the adhesive layer 3 to be, for example, 0.2 mm or more, and preferably 0.5 mm or more. The thickness of the adhesive layer 3 should be, for example, 0.2-1 mm.

From the perspective of ensuring breathability, it is suitable for the thickness of the band-like parts 3a to be determined so as to ensure that the area of the non-formed parts 2a relative to the overall lower face of the ventilation layer 2 is sufficient. This width can be, for example, 1-10 mm.

The interval between mutually adjacent band-like parts 3a is preferably a reasonably low value, for example 20 mm or less (and preferably 10 mm or less) so that unevenness does not occur at the surface of the waterproof sheet 10. In addition, this interval can be, for example, 1 mm or more because breathability decreases if this interval is too small.

Breathability is low if the ratio of the area of non-formed parts 2a relative to the overall lower face of the ventilation layer 2 is low, and adhesion to the foundation 40 decreases if this ratio is too high, and it is therefore suitable for this ratio to be 10-90% (and preferably 10-40%).

The shape of the adhesive layer 3 is not particularly limited. The adhesive layer may be formed continuously or discontinuously.

The waterproof sheet 10 can be laid by laminating a release paper or resin release film on the adhesive layer 3 prior to use and detaching the release paper or release film at the site of installation.

The shape of the waterproof sheet 10 in a planar view is not particularly limited, and may be, for example, polygonal (rectangular or the like), an irregular shape or circular. The shape of the waterproof sheet 10 in a planar view can be determined according to the shape of the target region 42 in a planar view. For example, in cases where the target region 42 is rectangular in a planar view, the laying region 43 can be a rectangular shape similar to that of the target region 42 in a planar view. The laying region 43 is preferably a region that is distant from the rim 42a of the target region 42. The peripheral region 44 is a rectangular region having a fixed width that surrounds the rectangular laying region 43 in a planar view.

As shown in FIG. 1, the waterproof sheet 10 is laid on the laying region 43, which is a part of the target region 42 (the entire region of the foundation 40).

The waterproof coating film 20 is formed by applying a liquid waterproofing material comprising a polyurethane-based resin. The liquid waterproofing material can be a one pack type (moisture curing type) or a two pack type.

One pack type (moisture curing type) liquid waterproofing materials can be classified into two types. One is a type in which curing occurs by moisture in the air reacting directly with an isocyanate component in the liquid waterproofing material. This type is referred to as the first type. The other is a type in which the liquid waterproofing material contains at least two components, that is, contains component 1 and component 2. Component 2 does not react with component 1, but forms a component 2′ upon contact with moisture in the air, and curing progresses as a result of component 2′ reacting with component 1. Component 2 is generally known as a latent curing agent. This type is referred to as the second type.

A waterproofing material of the first type contains, for example, a polyisocyanate and a polyol. Examples of polyisocyanates include low molecular weight isocyanate compounds such as diphenylmethane-4,4′-diisocyanate (MDI), carbodiimide-modified diphenylmethane diisocyanates (liquid MDI), polymethylene polyphenyl isocyanates (crude MDI), 2,4-tolylene diisocyanate (2,4-TDI), 2,6-tolylene diisocyanate (2,6-TDI), xylylene diisocyanate (XDI) and hexamethylene diisocyanate. The polyol is not particularly limited as long as the polyol contains two or more hydroxyl groups, but examples thereof include polyether polyols, polyester polyols and poly(tetramethylene glycol).

A waterproofing material of the first type may be, for example, a urethane prepolymer obtained by reacting a polyisocyanate and a polyol.

A waterproofing material of the second type contains, for example, a polyisocyanate (component 1) and a latent curing agent (component 2).

The polyisocyanates listed as polyisocyanates able to be used in a waterproofing material of the first type can be used as this polyisocyanate (component 1). The urethane prepolymer mentioned above can be used as the polyisocyanate (component 1).

The latent curing agent reacts with water and generates an active hydrogen group. Latent curing agents include hydrolysis type latent curing agents and thermal latent curing agents. Hydrolysis type latent curing agents do not function as curing agents in water-free environments, but hydrolyse and function as curing agents under conditions where water (moisture) is present. Examples of hydrolysis type latent curing agents include oxazolidine compounds and ketimine compounds. Thermal latent curing agents do not function as curing agents at ordinary temperatures, but melt, dissolve or activate and function as curing agents when at least a certain quantity of heat is applied. Examples of thermal latent curing agents include dicyandiamide and imidazole compounds.

Two pack type liquid waterproofing materials are used by, for example, transporting a main agent containing a polyisocyanate and a curing agent containing a polyfunctional active hydrogen compound that is reactive with an isocyanate group in separate containers to a site of use and then mixing the main agent and the curing agent at the site of use.

The waterproof coating film 20 is applied on the surface of the rim part 11 of the waterproof sheet 10 (the upper face 1b of the resin sheet 1) from the peripheral region 44, and formed so as to be in contact with the upper face 1b of the resin sheet 1. As a result, it is possible to prevent water from infiltrating from the rim of the waterproof sheet 10 to the lower face side of the waterproof sheet 10. The rim part 11 is a band-like part that includes the outer rim 10a of the waterproof sheet 10. In FIG. 1, the outer rim 20a of the waterproof coating film 20 reaches the parapet 41. The inner rim 20b of the waterproof coating film 20 is positioned further inwards than the outer rim 10a of the waterproof sheet 10.

### Waterproofing Method

An explanation will now be given of an example of a waterproofing method in which the waterproof structure 30 is installed.

### First Step

As shown in FIG. 1, the waterproof sheet 10 is laid on the laying region 43 of the foundation 40 (target region 42). By bonding the adhesive layer 3 to the foundation 40, the waterproof sheet 10 is fixed to the foundation 40. By using a self-adhesive as the adhesive layer 3, installation is facilitated because there is no need to apply a treatment agent to the surface of the foundation 40. In cases where the surface of the foundation 40 is brittle, it is possible to increase adhesive strength to the adhesive layer 3 by applying a urethane resin-based or epoxy resin-based primer so as to strengthen the surface of the foundation 40.

### Second Step

The waterproof coating film 20 is formed by blowing or coating, or the like, of a liquid waterproofing material. The liquid waterproofing material can be applied using, for example, a spray gun, a roller, a trowel or a rake. In this way, the waterproof structure 30 comprising the waterproof sheet 10 and the waterproof coating film 20 is formed.

In the waterproof structure 30, the surface (upper face 1b) of the resin sheet 1 that is in contact with the waterproof coating film 20 contains a reactive material that reacts with a component of the waterproof coating film 20. As a result, the waterproof coating film 20 is strongly bound to the resin sheet 1 by means of chemical bonding.

For example, in cases where the liquid waterproofing material is the first type, a hydroxyl group (—OH) in the reactive material having a hydroxyl group reacts with an isocyanate group (—N═C═O) (a component of a polyurethane-based resin) in the liquid waterproofing material, thereby forming an amide bond (—NH—C(═O)—) and causing curing to progress. In the case of amino group-containing reactive materials, curing progresses as a result of amino groups (—NH₂) reacting with isocyanate groups (—N═C═O) in the liquid waterproofing material to form urea bonds (—NH—C(═O—NH—). In the case of carboxyl group-containing reactive materials, curing progresses as a result of carboxyl groups (—COOH) reacting with isocyanate groups (—N═C═O) in the liquid waterproofing material to ultimately form amide bonds (—NH—C(═O)—) via a carbamic acid anhydride. In the case of thiol group-containing reactive materials, curing progresses as a result of thiol groups (—SH) reacting with isocyanate groups (—N═C═O) in the liquid waterproofing material to form thiourethane bonds (—S—C(═O)—NH—).

In a liquid waterproofing material of the second type, the latent curing agent reacts with the reactive material to generate a compound having an active hydrogen-containing functional group, and curing progresses as a result of the active hydrogen-containing compound reacting with an isocyanate (a component of the polyurethane-based resin).

In cases where the latent curing agent reacts with the reactive material to generate an isocyanate group-containing compound, curing progresses as a result of this isocyanate group-containing compound reacting with a polyol in the liquid waterproofing material.

In cases where a two pack type liquid waterproofing material is used, the reactive material reacts with a component of the liquid waterproofing material (a component of the polyurethane-based resin), as described above, thereby causing curing of the liquid waterproofing material to progress.

In the waterproof structure 30, because the waterproof coating film 20 is bound strongly to the resin sheet 1, it is possible to prevent the occurrence of peeling between the resin sheet 1 and the waterproof coating film 20 regardless of whether the resin sheet 1 comprises a material that contains a poly(vinyl chloride)-based resin. Therefore, it is possible to obtain a waterproof structure 30 having excellent waterproofing performance even in cases where an installer does not possess special skills. Therefore, there are few restrictions such as requiring installation by skilled installers, and installation can be easily carried out.

In addition, because the waterproof coating film 20 is bound strongly to the resin sheet 1 without applying a special use primer to the resin sheet 1, installation is facilitated in this respect.

In the waterproof structure 30, the surface of the resin sheet 1 that is in contact with the waterproof coating film 20 contains a reactive material that reacts with a component of the waterproof coating film 20, meaning that the waterproof coating film 20 is bound to the resin sheet 1 by means of chemical bonding such as that mentioned above. As a result, it is possible to reliably prevent peeling between the resin sheet 1 and the waterproof coating film 20. Therefore, there are few restrictions such as requiring installation by skilled installers, and installation can be carried out more easily.

In the waterproof structure 30, because the adhesive layer 3 is formed only on a partial region of the resin sheet 1 via the ventilation layer 2, in cases where gas such as water vapour is generated from the foundation 40, this gas flows into spaces 4 between the non-formed parts 2a and the foundation 40. As a result, it is possible to suppress a pressure increase caused by this gas and prevent swelling of the waterproof sheet 10.

In this waterproof structure 30, because the waterproof coating film 20 is provided from the rim part 11 of the waterproof sheet 10 to the peripheral region 44, the waterproof sheet 10 can be fixed to the foundation 40 without using fixing tools. Because fixing tools are not required, noise and vibration caused by drilling work does not occur.

In the waterproof structure 30, because the rim part 11 of the waterproof sheet 10 is fixed to the foundation 40 by means of the waterproof coating film 20, the waterproof sheet 10 is unlikely to peel from the foundation 40 even in areas of strong wind.

When attempting to waterproof a target region using only waterproof sheets, many joints occur in waterproof sheets in the peripheral region, for example, and it is thought that waterproofing performance tends to decrease.

In the waterproof structure 30, however, because it is possible to waterproof the peripheral region 44 by means of the waterproof coating film 20, it is possible to ensure waterproofing performance even in the peripheral region 44. In addition, even in locations where the foundation 40 has a complex shape, it is possible to install the waterproof sheet 10 avoiding such locations, with such locations being waterproofed by means of the waterproof coating film 20. Therefore, it is possible to prevent a decrease in waterproofing performance.

In the waterproof structure 30, because the adhesive layer 3 is partially formed on the ventilation layer 2, in cases where gas such as water vapour is generated from the foundation 40, this gas enters the ventilation layer 2 from the non-formed parts 2a and flows in the ventilation layer 2, as shown by the arrows in FIG. 4. As a result, sufficient breathability can be ensured even in cases where the spaces 4 narrow or close as a result of deformation of the adhesive layer 3. Therefore, it is possible to prevent swelling of the waterproof sheet 10.

In the waterproof structure 30, because the ventilation layer 2 functions as a ventilation pathway, the size and shape of the adhesive layer 3 are not restricted. For example, it is possible to ensure a sufficient amount of ventilation even if the area of the non-formed parts 2a is small. In addition, no problems in terms of breathability occur even if the non-formed parts 2a are discontinuous. As a result, the size and shape of the non-formed parts 2a can be determined so that no unevenness occurs at the surface of the waterproof sheet 10. Therefore, it is possible to form a waterproof structure 30 that is excellent in terms of appearance. In addition, because the size and shape of the adhesive layer 3 can be arbitrarily selected, the size of the adhesive layer 3 can be set so as to achieve satisfactory adhesive strength to the foundation 40.

In the waterproof structure 30, because it is not necessary to use an adhesive for bonding the waterproof sheet 10 to the foundation 40, problems caused by organic solvents added to an adhesive (for example, adverse effects on the environment and humans, incidents such as fires, and the like) do not occur. Because the waterproof sheet 10 is used in the waterproof structure 30, there are few problems in terms of reduced operational efficiency caused by coating work.

In the waterproof sheet 10, the waterproof coating film 20 is bound strongly to the resin sheet 1 as a result of chemical bonding such as that described above. Therefore, it is possible to prevent the occurrence of peeling between the resin sheet 1 and the waterproof coating film 20 regardless of whether the resin sheet 1 comprises a material that contains a poly(vinyl chloride)-based resin. Therefore, it is possible to obtain a waterproof structure 30 having excellent waterproofing performance even in cases where an installer does not possess special skills. Therefore, there are few restrictions such as requiring installation by skilled installers, and installation can be easily carried out.

In the waterproof sheet 10, because the adhesive layer 3 is formed only on a partial region of the resin sheet 1 via the ventilation layer 2, in cases where gas such as water vapour is generated from the foundation 40, this gas flows into spaces 4 between the non-formed parts 2a and the foundation 40. As a result, it is possible to suppress a pressure increase caused by this gas and prevent swelling of the waterproof sheet 10.

Because the waterproof sheet 10 can be fixed to the foundation 40 without using fixing tools, noise and vibration caused by drilling work does not occur. In addition, because the waterproof sheet is fixed to the foundation 40 by means of the waterproof coating film 20, the waterproof sheet is unlikely to peel from the foundation 40 even in areas of strong wind.

The waterproof sheet 10 is lightweight because the ventilation layer 2 is used, and exhibits excellent workability when laid. Because the adhesive layer 3 of the waterproof sheet 10 comprises a plurality of band-like parts 3a that are formed parallel to each other at intervals in the width direction, it is possible to form the adhesive layer 3 by continuously applying an adhesive at a fixed width along a fixed direction. As a result, production is easy and it is possible to increase production efficiency and reduce production costs.

FIG. 5 is a perspective view of a waterproof sheet used in another embodiment of a waterproof structure.

As shown in FIG. 5, this waterproof sheet 50 differs from the waterproof sheet 10 shown in FIG. 1 in that adhesive layers 53 are formed as independent islands. 52a denotes non-formed parts.

Moreover, this invention is not limited to the embodiments described above, and it is possible to make appropriate selections within limits that do not deviate from the gist of this invention.

For example, the waterproof coating film 20 is provided on the whole of the peripheral region 44 in the waterproof structure 30 shown in FIG. 1, but the waterproof coating film should be formed on at least a part of the peripheral region.

The waterproof coating film 20 covers the whole of the rim part 11 of the waterproof sheet 10 in the waterproof structure 30 shown in FIG. 1, but the waterproof coating film should be provided on at least a part of the surface of the rim part. In addition, the waterproof coating film may cover the whole of the surface of the waterproof sheet.

A reinforcing layer may be provided on a surface of the resin sheet (the upper face 1b shown in FIG. 1). The reinforcing layer may be formed from net-like fibres, and these fibres may be organic fibres, such as polyesters, polyamides and polyolefins, or glass fibres, metal fibres, and the like.

### REFERENCE SIGNS LIST

1: Resin sheet

1a: Lower face (one face)

1b: Upper face (surface, other face)

2: Ventilation layer

3, 53: Adhesive layer

10, 50: Waterproof sheet

11: Rim part

20: Waterproof coating film

30: Waterproof structure

42: Target region

44: Peripheral region

1. A waterproof structure which has
a waterproof sheet that is laid on a part of a target region of a foundation that is a flat site, and
a waterproof coating film that is formed on at least a part of a peripheral region of the target region on which the waterproof sheet is not laid, wherein
the waterproof sheet has a resin sheet containing a poly(vinyl chloride)-based resin and an adhesive layer which is provided on one side of the resin sheet and which is bonded to the foundation,
the adhesive layer is provided on a partial region of the resin sheet, and
the waterproof coating film contains a polyurethane-based resin and is provided so as to be in contact with the resin sheet on at least a surface of a rim part of the waterproof sheet.

2. The waterproof structure according to claim 1, wherein
at least the surface of the resin sheet that is in contact with the waterproof coating film contains a reactive material, and
the reactive material has or generates a functional group capable of reacting with a component of the polyurethane-based resin.

3. The waterproof structure according to claim 2, wherein the functional group is at least one type selected from among a hydroxyl group, an amino group, a carboxyl group and a thiol group.

4. The waterproof structure according to Claim 1, wherein the resin sheet has an amount of shrinkage in a thermally stretched state, as specified in JIS A6008, of 4 mm or less.

5. The waterproof structure according to Claim 1, wherein a breathable ventilation layer is provided between one face of the resin sheet and the adhesive layer.

6. A waterproof sheet, which has
a resin sheet containing a poly(vinyl chloride)-based resin and an adhesive layer which is provided on one side of the resin sheet and which is bonded to a foundation, wherein
the adhesive layer is provided on a partial region of the resin sheet,
at least the other face of the resin sheet contains a reactive material, and
the reactive material has or generates a functional group capable of reacting with a component of a polyurethane-based resin.

7. A waterproofing method which includes
a first step of laying a waterproof sheet on a part of a target region of a foundation that is a flat site, and
a second step of forming a waterproof coating film on at least a part of a peripheral region of the target region on which the waterproof sheet is not laid, wherein
the waterproof sheet has a resin sheet containing a poly(vinyl chloride)-based resin and an adhesive layer which is provided on one side of the resin sheet and which is bonded to the foundation,
the adhesive layer is provided on a partial region of the resin sheet, and
the waterproof coating film contains a polyurethane-based resin and is provided so as to be in contact with the resin sheet on at least a part of the surface of a rim part of the waterproof sheet.

8. The waterproofing method according to claim 7, wherein
at least the surface of the resin sheet that is in contact with the waterproof coating film contains a reactive material, and
the reactive material has or generates a functional group capable of reacting with a component of the polyurethane-based resin.

9. The waterproof structure according to claim 2, wherein the resin sheet has an amount of shrinkage in a thermally stretched state, as specified in JIS A6008, of 4 mm or less.

10. The waterproof structure according to claim 3, wherein the resin sheet has an amount of shrinkage in a thermally stretched state, as specified in JIS A6008, of 4 mm or less.

11. The waterproof structure according to claim 2, wherein a breathable ventilation layer is provided between one face of the resin sheet and the adhesive layer.

12. The waterproof structure according to claim 3, wherein a breathable ventilation layer is provided between one face of the resin sheet and the adhesive layer.

13. The waterproof structure according to claim 4, wherein a breathable ventilation layer is provided between one face of the resin sheet and the adhesive layer.

14. The waterproof structure according to claim 9, wherein a breathable ventilation layer is provided between one face of the resin sheet and the adhesive layer.

15. The waterproof structure according to claim 10, wherein a breathable ventilation layer is provided between one face of the resin sheet and the adhesive layer.
